(19) United States
(12) Patent Application Publication
(10) Pub. No.: US 2025/0375967 A1
(43) Pub. Date: Dec. 11, 2025

(54) PLOTTER FOR INKJET PRINTING

(71) Applicant: SYSTEM CERAMICS S.P.A., Fiorano Modenese (IT)

(72) Inventors: Paolo Casarini, Modenese (IT); Nicolo Pifferetti, Modenese (IT)

(21) Appl. No.: 18/874,495

(22) PCT Filed: Jun. 15, 2023
(86) PCT No.: PCT/IB2023/056194

§ 371 Date: Dec. 12, 2024

(30) Foreign Application Priority Data
Jun. 16, 2022 (IT) 102022000012734
May 23, 2023 (IT) 102023000010368

(51) Int. Cl. B41J 2/18; B41J 2/175; B41J 25/00; B41J 29/02

(52) U.S. Cl. CPC B41J 2/18; B41J 2/17523; B41J 2/17596; B41J 25/001; B41J 29/02

(57) ABSTRACT

A plotter for inkjet printing. The plotter comprises a frame comprising a sliding guide and a carriage slidably constrained thereto and movable along it in opposite first and second directions. The carriage supports printheads, each comprising a plurality of ink dispensing nozzles. An ink tank is arranged in a fixed position with respect to the frame. An ink recirculation circuit comprising a delivery branch and a return branch is provided. The plotter comprises a damper for the printheads, which is integral with the carriage and connected to at least one of the delivery branch and the return branch. The damper comprises an ink accumulation chamber and a compensation chamber. The ink accumulation chamber is in fluid communication with said recirculation circuit and the compensation chamber can be in fluid communication with the external environment, a source of compressed air or with a vacuum pump.

### CROSS-REFERENCE TO RELATED APPLICATION DATA

This application is a U.S. National Stage Application of International Application No. PCT/IB2023/056194, filed Jun. 15, 2023, which claims the benefit of and priority to Italian Patent Application No. 102022000012734, filed Jun. 16, 2022 and Italian Patent Application No. 102023000010368, filed May 23, 2023 the disclosure of each is incorporated herein by reference in its entirety.

### FIELD

The present invention relates to a plotter for inkjet printing. More particularly, the invention relates to a plotter for multipass inkjet printing in which ink droplets with a volume of a few picolitres are deposited in a controlled manner on a substrate, for example a ceramic substrate, a textile substrate, a plastic film or the like, by means of one or more printheads equipped with a plurality of dispensing nozzles.

### BACKGROUND

In multipass inkjet plotters, the printheads are mounted on a carriage that slides in two opposite directions along a guide travelling along the full width of the substrate to be printed, while the substrate is advanced perpendicularly to the sliding direction of the carriage. During ink deposition, the carriage travels along the guide at a substantially constant deposition speed. When the carriage has to reverse a sliding direction along the guide, the carriage undergoes a deceleration (necessary to stop the carriage from deposition speed) and a subsequent acceleration (necessary to bring the carriage back to deposition speed).

The ink fed to the printheads is drawn from tanks, each of which contains ink of a specific colour. Typically, one or more printheads are configured to dispense ink of a particular colour and are then placed in fluid connection with one or more respective tanks.

The printheads are of the ink recirculation type, i.e. the ink supply circuit to the printheads includes a recirculation circuit comprising a delivery branch through which ink is drawn from the tanks and fed to the printheads, and a return branch through which the part of the ink that was not dispensed by the nozzles during printing is fed back into the tanks. One or more pumps circulate the ink in the recirculation circuit and/or regulate the flow rates and pressures involved in the various circuit components.

For proper functioning of the printheads, the ink inside the printheads must be kept at a constant operating pressure, slightly lower by a few mbar, than the external pressure. This operating pressure is predetermined and linked to the dimensional, hydraulic and fluid-dynamic characteristics as well as the operating requirements of the specific printing device. In the plotters summarised above, there is a need to keep the weight of the carriage as low as possible, whose sliding speed can be up to 2 m/s and which can be subjected to accelerations and decelerations of 1 g when the carriage has to reverse direction.

### SUMMARY

The Applicant has noted that in order to limit the weight of the carriage, arranging the ink tanks integral with the carriage should be avoided, e.g. by arranging the ink tanks integral with a plotter frame. In this case, the recirculation circuit may comprise flexible tubes fluidically connecting the tanks to the printheads. These tubes can be arranged with first sections running from the tanks to the carriage guide, with second sections running the full length of the carriage and arranged parallel to the guide, and with third sections connected to the printheads. These second sections can be provided with first ends fixed to the frame and with second ends integral with the carriage. As the carriage travels along the rail, the second ends of the second sections follow the motion of the carriage, ensuring fluid connection with the tanks. Such a recirculation circuit, in inkjet plotters used for large-format printing, can reach lengths well in excess of 10 metres.

However, the Applicant has verified that the strong accelerations and decelerations to which the carriage is subjected are transmitted to the ink circulating within the recirculation circuit, causing temporary pressure increases and decreases within the recirculation circuit and thus within the printheads.

In fact, according to the Applicant's experience, the pressure variation (understood as an increase or decrease in pressure within the recirculation circuit) is directly proportional to the density of the ink, the acceleration of the carriage and the length of the recirculation circuit tubes measured in the same direction as the acceleration. Since the aforementioned second sections of the tubes running parallel to the carriage guide and along the entire length of the carriage guide (and thus running parallel to the direction of the carriage's accelerations and decelerations) can exceed 10 metres in length, the pressure increases or decreases within the recirculation circuit are not negligible.

The Applicant also noted that temporary pressure drops can occur inside a printhead even when such printhead is driven to dispense a large amount of ink (e.g. because a portion of the substrate is to be printed with a large amount of the same colour).

However, pressure deviations inside the printheads from the predetermined value cause nozzle malfunctions in ink dispensing. In fact, when the pressure drops too low compared to the operating pressure, the nozzles are unable to dispense sufficient ink, whereas when the pressure rises above the operating pressure, the nozzles tend to dispense excessive amounts of ink during printing. In both cases, the resulting print may not be of sufficient quality.

The Applicant perceived that by placing an accumulation chamber on the recirculation circuit capable of increasing its volume when the pressure inside it increases and decreasing its volume when the pressure inside it decreases, it is possible to compensate for temporary pressure increases in the recirculation circuit by increasing the volume of the accumulation chamber and compensate for temporary pressure decreases in the recirculation circuit by decreasing the volume of the accumulation chamber.

The Applicant has therefore found that by having at least one damper on the recirculation circuit, between the tank and the printheads, comprising an ink accumulation chamber fluidly connected to the recirculation circuit and separated from the ink accumulation chamber by an expandable septum, the volume of the ink accumulation chamber increases and decreases in response to an increase and decrease in pressure in the recirculation circuit respectively due to a deformation of the expandable septum.

The Applicant also found that by arranging the damper on the carriage, and thus in close proximity to the printheads, the damper is able to compensate for temporary increases and decreases in pressures in the recirculation circuit in the vicinity of the printheads, making the pressure inside the printheads essentially insensitive to temporary increases and decreases in pressure in the recirculation circuit.

The present invention therefore relates, in a first aspect thereof, to a plotter for inkjet printing.

Preferably, a frame comprising a sliding guide is provided.

Preferably, a carriage is provided that is slidably constrained to the sliding guide.

Preferably, such a carriage can be moved along the sliding guide in a first printing direction and in a second printing direction opposite to the first printing direction.

Preferably, the first printing direction and the second printing direction are contained in a sliding plane.

Preferably, the sliding plane is parallel to the sliding guide.

Preferably, the carriage supports at least one group of printheads.

Preferably, each printhead of the at least one group of printheads comprises a plurality of ink dispensing nozzles.

Preferably, there is at least one tank configured to contain ink.

Preferably, the at least one tank is arranged in a fixed position in relation to the frame.

Preferably, an ink recirculation circuit is provided.

Preferably, the ink recirculation circuit comprises a delivery branch configured to make ink flow from the at least one tank to the at least one group of printheads.

Preferably, the ink recirculation circuit comprises a return branch configured to make ink flow from the at least one group of printheads to the at least one tank.

Preferably, the ink recirculation circuit comprises a plurality of tubes.

Preferably, said tubes of the plurality of tubes extend at least partially parallel to the sliding plane.

Preferably, at least one damper is provided integral with the carriage.

Preferably, the at least one damper is connected to at least one between the delivery branch and the return branch of the ink recirculation circuit.

Preferably, the at least one damper is connected between the at least one tank and the at least one group of printheads.

Preferably, the at least one damper comprises an ink accumulation chamber and a compensation chamber fluidly separated from the accumulation chamber.

Preferably, the compensation chamber is fluidly separated from the accumulation chamber by an expandable septum.

Preferably, the ink accumulation chamber is in fluid communication with the ink recirculation circuit.

Preferably, the compensation chamber is in fluid communication with the external environment or with a compressed air source or vacuum pump.

In the remainder of this description and in subsequent claims, “sliding plane” may be identified as a plane tangent to a lower end of the sliding guide. Such plane is perpendicular to the nozzle emission direction and, in an operating condition of the plotter, parallel to a substrate to be printed. In preferred embodiments of the invention, such plane corresponds to a horizontal plane, with reference to the positioning of the plotter under normal operating conditions.

In the remainder of this description and in the subsequent claims, “nozzle emission direction” means a direction contained in a plane substantially perpendicular to the first and second printing directions. This direction is also substantially perpendicular to the first and second printing directions.

In the remainder of this description and in the subsequent claims, the term “flexible”, when referring to tubes, pipings, or ducts, is used to indicate the ability of such tubes, pipings, or ducts to follow different paths without becoming permanently deformed and damaged. In contrast, the term “rigid”, when referring to tubes, pipings, or ducts, is used to refer to tubes, pipings, or ducts that follow only one path and are not configured to follow different paths without becoming permanently deformed or damaged.

The present invention can have at least one of the preferred features described below. Such features may thus be present individually or in combination, unless explicitly stated otherwise, in the plotter for inkjet printing of the present invention.

Preferably, the at least one group of printheads comprises at least one printhead.

Preferably, the accumulation chamber of the at least one damper has an elongated shape.

Preferably, the accumulation chamber has a prevailing development axis parallel to the sliding plane and perpendicular to the first printing direction.

In this way the effect, in terms of increase and decrease of the ink pressure, that the accelerations and decelerations of the carriage cause on the ink contained in the accumulation chamber is minimised by the fact that the prevailing development axis of the accumulation chamber is parallel to the sliding plane and perpendicular to the first printing direction. This orientation of the prevailing development axis of the accumulation chamber is in fact perpendicular to the direction of the accelerations and decelerations to which the carriage is subjected during operation of the plotter.

Preferably, the accumulation chamber has a width dimension in a direction parallel to the sliding plane and parallel to the first printing direction.

Preferably, the accumulation chamber has a length dimension in a direction parallel to the sliding plane and perpendicular to the first printing direction.

Preferably, a ratio between the width dimension and the length dimension of the accumulation chamber is comprised between 0.1 and 0.6, more preferably comprised between 0.2 and 0.4, even more preferably comprised between 0.25 and 0.35.

Preferably, the compensation chamber of at least one damper has an elongated shape.

Preferably, the compensation chamber has a prevailing development axis parallel to the sliding plane and perpendicular to the first printing direction.

Preferably, the compensation chamber has a width dimension in the parallel direction to the sliding plane and parallel to the first printing direction.

Preferably, the compensation chamber has a length dimension in the parallel direction to the sliding plane and perpendicular to the first printing direction.

Preferably, a ratio between the width dimension and the length dimension of the compensation chamber is comprised between 0.1 and 0.6, more preferably comprised between 0.2 and 0.4, even more preferably comprised between 0.25 and 0.35.

Preferably, the accumulation chamber comprises a first opening and a second opening.

Preferably, the first opening of the accumulation chamber is connected to the at least one tank via tubes of said plurality of tubes.

Preferably, the second opening of the accumulation chamber is connected to the group of printheads via a distributor.

Preferably, the at least one damper is placed at a fixed and predetermined distance, along a direction perpendicular to the sliding plane, from said at least one group of printheads.

Such fixed distance between the damper and the group of printheads unambiguously determines, given the operating pressure of the printheads, the pressure at which the ink in the accumulation chamber must be.

Preferably, the expandable septum is an elastically deformable septum, or a movable septum, configured to modify an internal volume of the accumulation chamber.

Preferably, an increase in the volume of the accumulation chamber corresponds to a decrease in the volume of the compensation chamber.

Preferably, a decrease in the volume of the accumulation chamber corresponds to an increase in the volume of the compensation chamber.

Preferably, a change in volume (measured in absolute value) of the accumulation chamber corresponds to an equal change in volume (measured in absolute value) of the compensation chamber.

Preferably, the expandable septum includes an elastic membrane.

Preferably, said elastic membrane is configured to expand in an expansion direction towards the compensation chamber in order to increase the internal volume of the accumulation chamber and decrease the internal volume of the compensation chamber of the damper.

Preferably, said elastic membrane is configured to expand in the expansion direction towards the accumulation chamber to increase the internal volume of the compensation chamber and decrease the internal volume of the accumulation chamber of the damper.

Preferably, the compensation chamber comprises an opening.

Preferably, said opening in the compensation chamber places the compensation chamber in fluid communication with the external environment.

In alternative embodiments, said opening in the compensation chamber puts the compensation chamber in fluid communication with said compressed air source or with said vacuum pump.

The provision of a source of compressed air or a vacuum pump fluidly connected to the compensation chamber makes it possible to introduce pressurised air into or remove air from the compensation chamber and actively control the expansion of the expandable septum.

The provision of a compressed air source fluidly connected to the compensation chamber also allows the printhead nozzles to be cleaned of obstructions or residue. For example, when the at least one damper is connected to the delivery branch of the recirculation circuit, the cleaning operation is carried out by introducing compressed air at a much higher pressure than atmospheric pressure in such a way as to cause a sudden increase in the volume of the compensation chamber. This causes a sudden rise in the pressure of the ink in the accumulation chamber, which is delivered at high pressure to the printheads.

Preferably, said at least one damper includes a first damper connected to the return branch of the recirculation circuit.

Preferably, the first opening of the accumulation chamber of the first damper corresponds to an outlet of the ink from said accumulation chamber.

Preferably, the second opening of the accumulation chamber of the first damper corresponds to an inlet of ink into said accumulation chamber.

Preferably, said at least one damper comprises a second damper connected to the delivery branch of the ink recirculation circuit.

Preferably, said second damper is identical to said first damper.

Preferably, the first opening of the accumulation chamber of the second damper corresponds to an inlet of ink into said accumulation chamber.

Preferably, the second opening of the accumulation chamber of the second damper corresponds to an outlet of the ink from said accumulation chamber.

Preferably, the at least one group of printheads comprises a plurality of printheads.

Preferably, a ratio between a volume of the accumulation chambers of all the dampers and an average flow of ink flowing in the recirculation circuit is comprised between 10% and 100%, more preferably comprised between 20% and 80%, even more preferably comprised between 30% and 50% e.g. equal to about 36%.

Preferably, this average ink flow in the recirculation circuit is calculated according to the formula Q=Vn×Nn×Nh×f, where Vn=volume of ink emitted by each nozzle in a single activation, Nn=number of nozzles of each printhead, Nh=total number of printheads, f=frequency of nozzle emission.

Preferably, said distributor includes a primary return duct connected to the first damper.

Preferably, said distributor includes a primary delivery duct connected to the second damper.

Preferably, the primary return duct and the primary delivery duct run parallel to the sliding plane and perpendicular to the first printing direction.

Preferably, the primary return duct is connected to the first damper via a first connection tube.

Preferably, the primary return duct is connected to the first damper via the ink inlet in said accumulation chamber of the first damper.

Preferably, the primary delivery duct is connected to the second damper via a second connecting tube.

Preferably, the primary delivery duct is connected to the second damper via the ink outlet from said accumulation chamber of the second damper.

Preferably, said distributor comprises a plurality of secondary return ducts, each of which is connected to said primary return duct.

Preferably, said distributor comprises a plurality of secondary delivery ducts, each of which is connected to said primary delivery duct.

Preferably, said secondary return and delivery ducts run perpendicular to said sliding plane and are also connected to said plurality of printheads.

Preferably, said secondary return ducts have a fixed, predetermined length dimension in the direction orthogonal to the sliding plane.

Preferably, said secondary delivery ducts have a fixed, predetermined length dimension in the direction orthogonal to the sliding plane.

Preferably, said secondary return and delivery ducts have an equal length dimension.

Preferably, the primary return duct, the primary delivery duct, the secondary return ducts and secondary delivery ducts are rigid ducts.

Preferably, the primary return duct, the primary delivery duct, the secondary return ducts and the secondary delivery ducts are essentially straight.

Preferably, the primary return duct and secondary return ducts are part of the return branch of the ink recirculation circuit.

Preferably, the primary delivery duct and secondary delivery ducts are part of the delivery branch of the ink recirculation circuit.

Preferably, each printhead of the plurality of printheads is connected to a secondary return duct and a secondary delivery duct.

Preferably, each secondary return duct is connected at an ink outlet of one printhead of said plurality of printheads.

Preferably, each secondary delivery duct is connected at an ink inlet of one printhead of said plurality of printheads.

Preferably, said distributor comprises at least one bypass tube connected between the respective terminal ends of the primary return duct and the primary delivery duct.

The provision of a bypass tube connected in such manner establishes an additional flow of ink circulating continuously in the primary return duct and the primary delivery duct. This additional flow prevents ink from accumulating and stagnating at the terminal ends of the primary return duct and the primary delivery duct.

Preferably, there is a plurality of groups of printheads, each group of printheads comprising a respective plurality of printheads, respective first and second dampers and a respective distributor.

Preferably, a first pump is provided, configured to regulate pressure at at least one between the first damper and the second damper.

Preferably, said first pump is connected to the first damper.

Preferably, said first pump is configured to regulate, preferably indirectly, an ink pressure flowing into the accumulation chamber of the first damper.

Preferably, said first pump is configured to actively control the expansion of the expandable septum.

Preferably, said first pump is configured to operate in response to pressure variations at the inlet to said plurality of printheads.

Preferably, said first pump is fluidly connected to the compensation chamber of the first damper to regulate an air pressure in said compensation chamber.

Preferably, said first pump is configured to apply a depression in the compensation chamber of the first damper.

Preferably, said first pump is configured to increase the depression applied in the compensation chamber of the first damper in response to a decrease in inlet pressure acting on the plurality of printheads.

Preferably, said first pump is a vacuum pump.

A second pump is provided at constant pressure, said second pump preferably being connected in parallel to the return branch of the recirculation circuit.

Preferably, said second pump is configured to set a predetermined, preferably constant, pressure value at an ink outlet of the first damper.

Preferably, a third pump is set to deliver a constant ink flow rate, said first pump being connected to the delivery branch of the recirculation circuit.

Preferably, a first pressure sensor is mounted along the delivery branch of the ink recirculation circuit to measure the pressure at the inlet to the plurality of printheads.

Preferably, said first pressure sensor is connected between the second damper and the primary delivery duct.

Preferably, said first pressure sensor is connected at a central region of the second primary duct, said central region being comprised between two ends of the primary delivery duct.

Preferably, said first pressure sensor is connected to the second connecting tube.

Preferably, an output of said first pressure sensor is used to control the first pump.

In some embodiments, there is a plurality of first pressure sensors, each first pressure sensor being connected in proximity to an ink inlet of each printhead of the plurality of printheads.

The provision of a first pump that actively regulates the ink pressure in the first damper allows it to react quickly to pressure fluctuations at the inlet to the printheads, restoring the predetermined differential pressure of the printheads linked to optimal nozzle operation.

Preferably, said at least one sensor includes a second pressure sensor mounted along the return branch of the ink recirculation circuit.

Preferably, said second pressure sensor is connected between the first damper and the primary return duct.

Preferably, said second pressure sensor is connected at a central region of the primary return duct, said central region being comprised between two ends of the primary return duct.

Preferably, said second pressure sensor is connected to the first connecting tube.

Alternatively, said second pressure sensor is connected to or near the first damper for measuring the pressure acting in said first damper.

In embodiments, said second pressure sensor is connected to the compensation chamber of the first damper for measuring the pressure acting in said compensation chamber of the first damper.

Preferably, an output of said second pressure sensor is used to control the second constant-pressure pump.

Preferably, the second pump is configured to regulate the operating point of the first pump based on the output of the second pressure sensor.

Preferably, the second pump is configured to return the first pump to its optimum operating point following deviations.

Preferably, said plurality of tubes extends at least partially parallel to the first printing direction and the second printing direction.

Preferably, the tubes of said plurality of tubes are at least partly flexible.

Preferably, said sliding guide has a straight extension.

### BRIEF DESCRIPTION OF THE DRAWINGS

Further features and advantages of the present invention will become clearer from the following detailed description of a preferred embodiment thereof, with reference to the appended drawings and provided by way of indicative and non-limiting example, in which:

FIG. 1 is a schematic front perspective view of the plotter in accordance with the present invention;

FIG. 2 is a schematic rear perspective view of the plotter in accordance with the present invention;

FIG. 3 is a schematic front view of components of the plotter of FIG. 1;

FIG. 4 is a schematic side view of components of the plotter of FIG. 1;

FIG. 5 is a schematic perspective view of components of the plotter of FIG. 1;

FIG. 6 is an exploded schematic view of the components of the plotter shown in FIG. 5;

FIG. 7 is a sectional view according to the plane A-A shown in FIG. 5; and

FIG. 8 is a schematic perspective view of the components of the plotter of FIG. 1; and

FIG. 9 is a schematic representation of the plotter according to a further embodiment of the invention.

### DETAILED DESCRIPTION

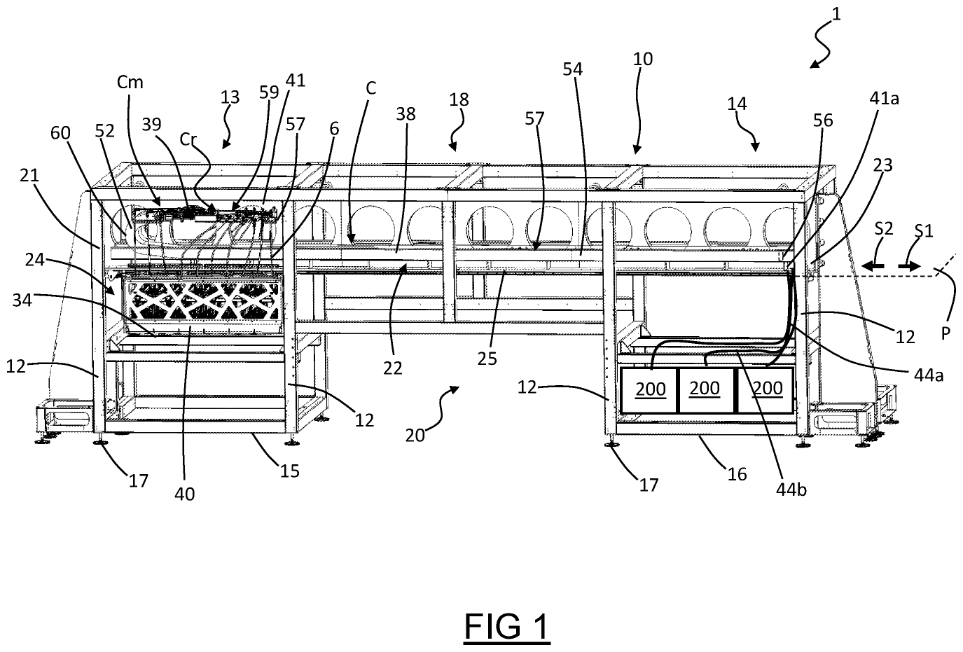

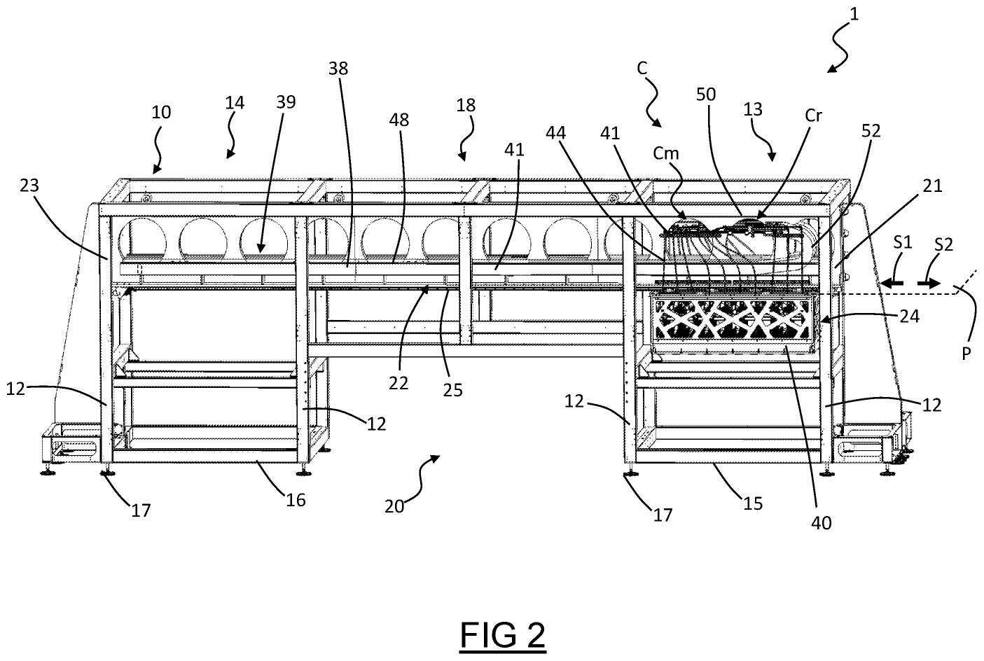

A plotter is indicated by the numerical reference 1 in FIGS. 1 and 2.

The plotter 1 comprises a frame 10 formed by uprights 12 connected by cross members 14 (only some shown in FIG. 1) and other structural components known in the state of the art.

The frame 10 comprises two lateral first and second load-bearing structures 13, 14 configured to rest on the ground at respective bases 15, 16 provided with feet 17.

The load-bearing structures 13, 14 are connected to each other by a bridge structure 18 arranged at a distance from a plane containing the bases 15, 16 of the load-bearing structures 13, 14.

The empty space comprised between the load-bearing structures 13, 14 and below the bridge structure 18 of the frame 10 defines a printing region 20 adapted to receive a generally planar substrate to be printed (not shown). In an operating condition of the plotter 1, the substrate to be printed is introduced into the printing region 20 by means of conveyor belts, rollers or other suitable handling devices mounted on suitable support frames.

The frame 10 includes a sliding rail 22 defining a first straight printing direction S1, whose direction runs from left to right in FIG. 1, and a second straight printing direction S2 opposite the first printing direction S1 and running from right to left in FIG. 2.

The first and second printing directions S1, S2 are contained in a sliding plane P tangent to a lower end of the sliding guide 22 and corresponding in the case shown to a horizontal plane. In the operating condition of the plotter 1, the sliding plane P is also parallel to the substrate to be printed.

The sliding rail 22 extends between a first end 21 located at the first load-bearing structure 13 and a second end 23 located at the second load-bearing structure 14, passing through the bridge region 18 and over the printing region 20. The sliding guide 22 comprises one or more rails 25.

The plotter 1 comprises a carriage 24 slidably constrained to the sliding guide 22. For example, the carriage 24 is moved along the sliding guide 22 by one or more electric motors not illustrated.

During printing, as the carriage 24 slides along the sliding guide 22, the substrate to be printed is advanced in the printing region 16 parallel to the sliding plane P and orthogonally to the first and second printing directions S1, S2.

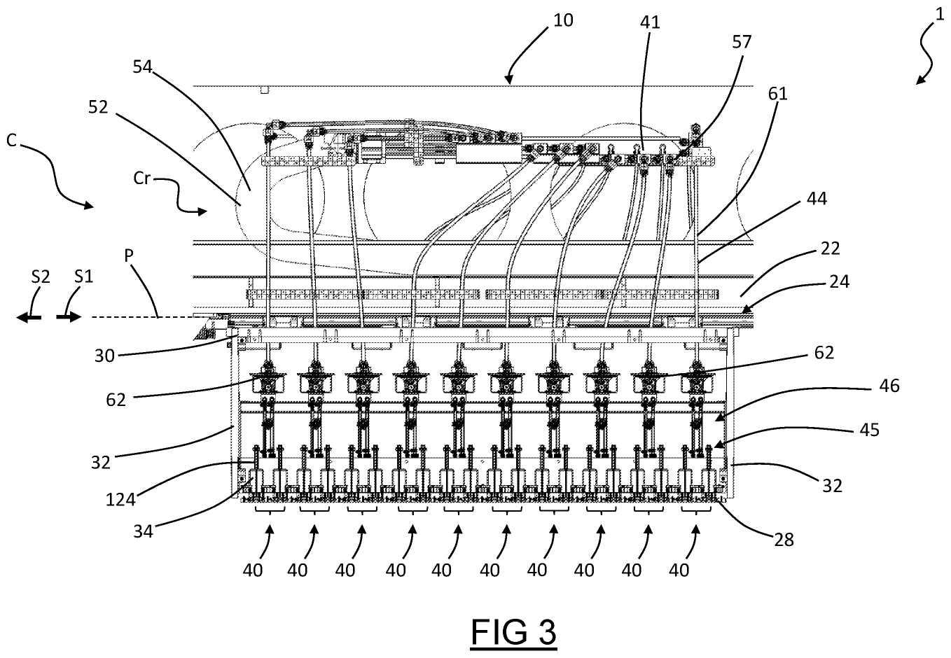

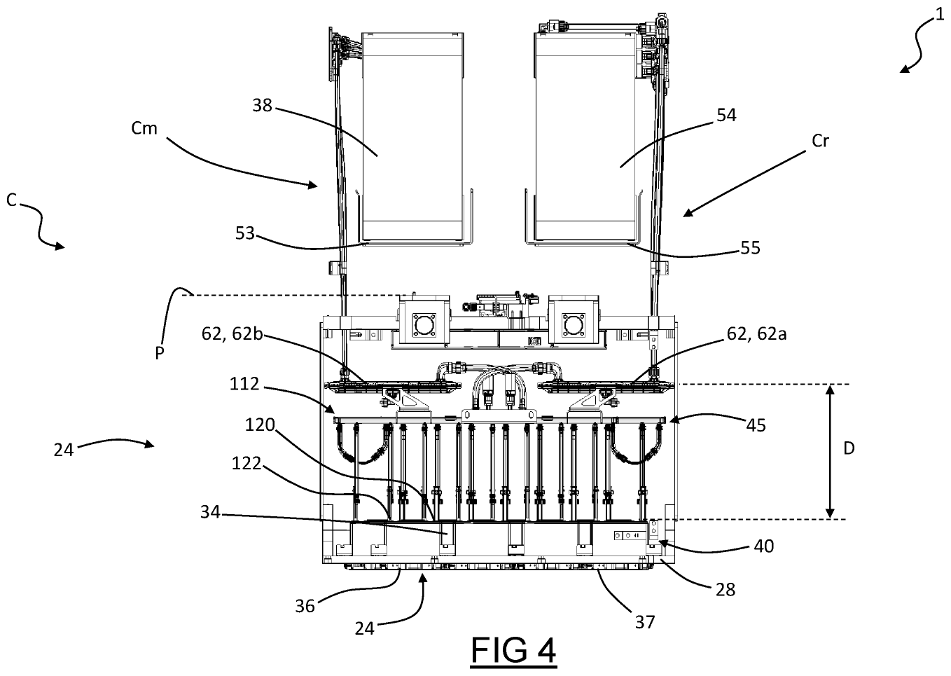

As can be better seen in FIGS. 3 and 4, the carriage 24 is configured as a containment structure comprising a base 28, an upper wall 30 and four side walls 32, two of which have been removed from FIGS. 3 and 4 for clarity of presentation.

The carriage 24 houses a plurality of printheads 34.

The printheads 34 are of the ink recirculating type and are designed to dispense ink onto the substrate to be printed when the plotter 1 is operating. The printheads 34 comprise an internal chamber into which ink is made to flow, and a plurality of ink-emitting nozzles at one of their lower faces 36. The ink-emitting nozzles, which are not directly visible, are shown for simplicity purposes in FIG. 4 with reference 37 at the lower face 36 of a printhead 34.

The pressure inside each printhead 34 must, for optimum operation of the nozzles 37, be set to a predetermined differential pressure relative to the external environment. Preferably, this differential pressure is 2 mbar lower than the external environment.

In the embodiment illustrated in the accompanying figures, the printheads 34 are divided into ten groups 40 of printheads 34. Each group 40 of printheads 34 includes eight printheads 34 divided into two parallel rows of four printheads 34 each, as can be deduced from FIGS. 3 and 4.

The lower face 36 of the printheads 34 emerges inferiorly through openings made in the base 28 of the carriage 24 so as to externally expose the outlet of the nozzles 37.

The plotter 1 is in particular configured to perform an inkjet printing process. Each of the nozzles 37 of the printheads 34 comprises a selective activation mechanism that may be based on thermal technology or piezoelectric technology, comprising in the first case a resistor and in the second case a piezoelectric material channel in proximity to the nozzle outlet, as well as associated electrical circuitry configured to activate the resistor or piezoelectric channel.

The plotter 1 also comprises one or more tanks 200, illustrated schematically in FIG. 1, in which ink is stored to be fed to the printheads 34 during the printing process.

The tanks 200 are in a fixed position in relation to the frame 10 of the plotter 1. For example, the tanks 200 can be arranged within the space confined by the uprights 12 and cross members 14 of the support structure 17 of the frame 10 located on the right in FIG. 1.

The plotter 1 comprises an ink recirculation circuit, collectively referred to as C in the figures, configured to feed ink to the printheads 34.

The recirculation circuit C comprises a plurality of tubes 39 configured to circulate ink from the tanks 200 to the printheads 34 and from the printheads 34 to the tanks 200.

The recirculation circuit C includes a delivery branch Cm, through which ink is fed from the tanks 200 to the printheads 34, and a return branch Cr, through which ink from the printheads 34 returns to the tanks 200. The continuous recirculation of ink not used for printing counteracts ink stagnation and prevents it from drying out in the printheads 34, clogging their nozzles 37.

Said plurality of tubes 39 comprises first flexible main tubes 38 visible in FIG. 2 and schematically shown in FIG. 4, which form part of the delivery branch Cm.

The first main tubes 38 extend above the sliding plane P between respective first ends 41a and second ends 41.

First delivery connectors 44a (depicted in FIG. 1), which connect the first ends 41a of the first main tubes 38 to the ink tanks 200, are part of the delivery branch Cm of the recirculation circuit C.

The delivery branch Cm also comprises second delivery connectors 44 (FIG. 3) connected to the second ends 41 of the first main tubes 38 and configured to send ink to the printheads 34.

The first ends 41a of the first main tubes 38 are in a fixed position in relation to the frame 10 of the plotter 1, being located, for example, at the load-bearing structure 14 on the right in FIG. 1, in proximity to the second end 23 of the sliding guide 22.

The second ends 41 of the first main tubes 38 are made integral with the carriage 24 in such a way that they are drawn by the carriage 24 in its sliding motion in the first and second printing direction S1, S2 along the sliding guide 22.

In order to be able to follow the movement of the carriage 24, the first main tubes 38 form a loop 52 between a first section 48 of the first main tubes 38 and a second section 50 of the first main tubes 38.

The first section 48 and the second section 50 run substantially parallel to each other and parallel to the first sliding direction S1 and the second sliding direction S2. The second section 50 of the first main tube 38 is substantially superimposed on the first section 48. The first section 48 is supported by a first housing 53 fixed to the sliding guide 22 (FIG. 4), above the rails 25 onto which the carriage 34 is hooked.

When the carriage 24 is located at the first end 21 of the sliding guide 22, as in the case shown in FIG. 1, the first section 48 takes a maximum extension and the second section 50 takes a minimum extension.

When the carriage 24 is at the second end 23 of the sliding guide 22, the first section 48 takes a minimum extension and the second section 50 takes a maximum extension. In this case, the loop 52 is located in a central region of the sliding guide 22, at the bridge structure 18 of the frame 10.

Said plurality of tubes 39 comprises second flexible main 54 tubes, visible in FIG. 1 and depicted in FIG. 4, which form part of the return branch Cr.

The second main tubes 54 extend above the sliding plane P between respective third ends 56 and fourth ends 57. The second main tubes 54 run parallel along a direction transverse to the first sliding direction S1 to the first main tubes 38 of the delivery branch Cm.

First return connectors 44b, which connect the third ends 56 of the second main tubes 54 to the ink tanks 200, are part of the return branch Cr of the recirculation circuit C.

The return branch Cr also comprises second return connectors 61 connected to the fourth ends 58 of the second main tubes 54 and configured to receive ink from the printheads 34.

The third ends 56 of the second main tubes 54 are in a fixed position in relation to the frame 10 of the plotter 1, being for example close to the first ends 41a of the first main tubes 38, at the support structure 14 on the left in FIG. 2 and close to the second end 23 of the sliding guide 22.

The fourth ends 58 of the second main tubes 54 are made integral with the carriage 24 in order to be dragged by the carriage 24 in its sliding motion in the first and second printing direction S1, S2 along the sliding guide 22.

Similar to what has been described above for the first main tubes 38, the second main tubes 54 form a loop 60 between a third section 57 of the second main tubes 54 and a fourth section 59 of the second main tubes 54.

The third section 57 and the fourth section 59 run substantially parallel to each other and parallel to the first and second sliding directions S1, S2. The fourth section 59 is substantially superimposed on the third section 57 of the second main tube 54. The third section 57 is supported by a second housing 55 fixed to the sliding guide 22 (FIG. 4), above the rails 25 onto which the carriage 34 is hooked.

When the carriage 24 is at the first end 21 of the sliding guide 22, as in the case shown in FIG. 1, the third section 57 assumes a maximum extension and the fourth section 59 assumes a minimum extension.

When the carriage 24 is at the second end 23 of the sliding guide 22, the third section 57 assumes a minimum extension and the fourth section 59 assumes a maximum extension. In this case, the loop 60 is located in a central region of the sliding guide 22, at the bridge structure 18 of the frame 10.

There are one or more pumps (not shown) configured to move ink along the recirculation circuit C. For example, there may be a first flow-controlled pump connected along the delivery branch Cm of the recirculation circuit C and configured to deliver a constant flow of ink, and a pressure-controlled pump positioned in parallel to the return branch Cr and configured to operate at a constant pressure.

The plotter 1 comprises a plurality of dampers 62 in fluid communication with the recirculation circuit C, one of which is illustrated in FIGS. 4-6.

Each damper 62 comprises a container body 64, comprising a first shell 66 and a second shell 68 made of a rigid material joined together at respective coupling flanges 70, 72 by means of fastening members 73, for example screws, bolts or the like.

The first shell 66 and the second shell 68 define a first concavity 74 and a second concavity 76, respectively, facing each other in the assembled condition of the damper 62. The first and second concavities 74, 76 are delimited by respective edges 78, 80 with a substantially corresponding perimeter extension (FIG. 7).

The damper 62 comprises a membrane 82, made, for example, of an elastomer material.

In the assembled condition of the damper 62, the membrane 82 is interposed between the first and second shells 66, 68. A perimeter edge 84 of the membrane 82 is fastened at the coupling flanges 70, 72, using the same fastening members used to hold the first and second shells 66, 68 together.

In the assembled condition, the membrane 82 is retained between the edges 78, 80 of the first and second concavities 74, 76. In this way, the membrane 82 closes and physically separates the first concavity 74 and the second concavity 76 from each other.

Each damper 62 comprises an accumulation chamber 88. The accumulation chamber 88 is defined between the first concavity 74 of the first shell 66 and the membrane 82. The accumulation chamber 88 comprises a first opening 90 and a second opening 92 made at the first shell 66.

Each damper 62 comprises a compensation chamber 94. The compensation chamber 94 is defined between the second concavity 74 of the second shell 68 and the membrane 82. The compensation chamber 94 comprises a third opening 96 made at the second shell 68.

The accumulation chamber 88 is distinct and fluidly separated from the compensation chamber 94.

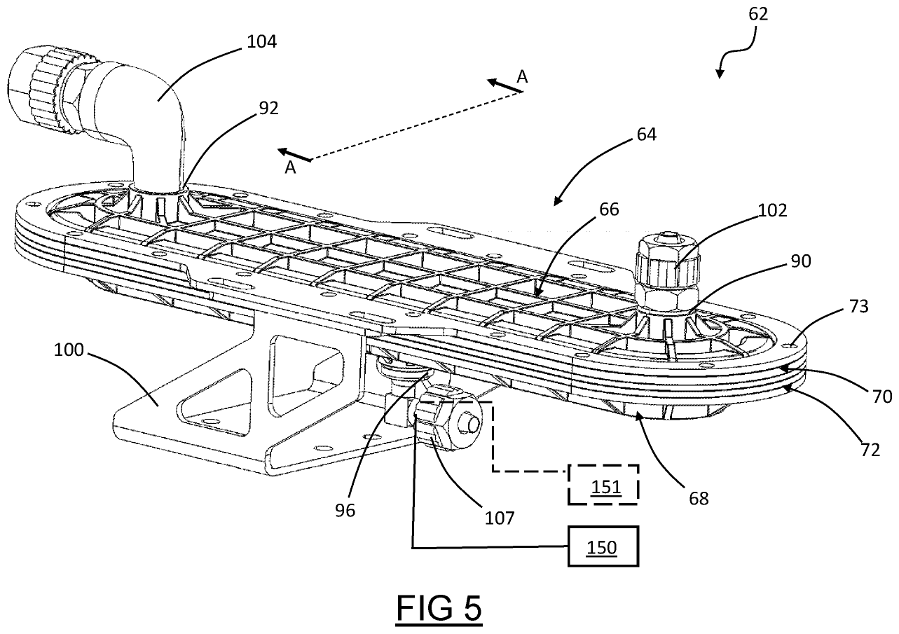

A first and second connector 102, 104 are also provided at the first and second openings 90, 92 configured to place the accumulation chamber 88 of the damper 62 in fluid connection with the ink recirculation circuit C. A plug 107 is provided at the third opening 96, which when the plotter is in use is removed to place the compensation chamber 94 in communication with the external environment or with a source of compressed air 150 (shown schematically in FIG. 5) or with a vacuum pump 151 (shown schematically and in with a broken line in FIG. 5).

By virtue of its elasticity, the membrane 82 is able to deform along an expansion direction E perpendicular to the sliding plane S, expanding towards the compensation chamber 94 or towards the accumulation chamber 88. During its expansion, the membrane 82 remains constrained to the container body 64 at the perimeter margin 84.

The membrane 82 expands in the expansion direction E towards the compensation chamber 94 or towards the accumulation chamber 88 respectively in response to an ink pressure within the accumulation chamber 88 below a predetermined operating pressure or above said predetermined operating pressure, and under the action of a constant pressure within the compensation chamber 94.

The damper 62 also comprises gaskets 98 for sealing the accumulation chamber 88 and the compensation chamber 94.

The accumulation chamber 88 and compensation chamber 94 are elongated in a direction perpendicular to the first sliding direction S1.

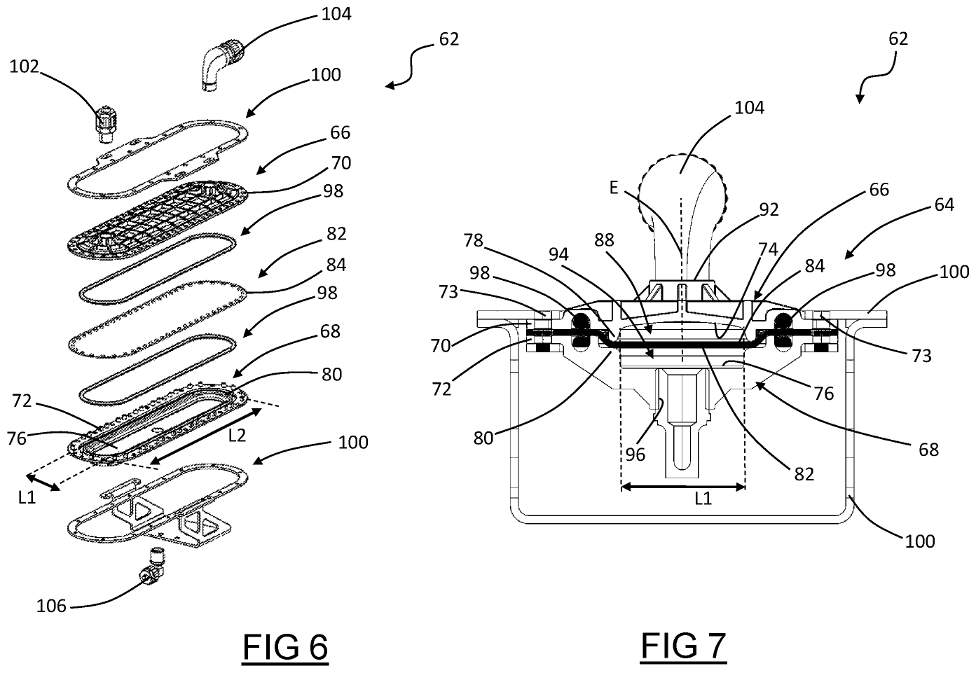

The accumulation chamber 88 and compensation chamber 94 have the same length dimension L2 and width dimension L1, both shown in FIG. 6. In the example shown, the ratio between the width dimension L1 and length dimension L2 of the accumulation chamber 88 and the compensation chamber 94 is comprised between 0.15 and 0.55, preferably comprised between 0.25 and 0.45, more preferably comprised between 0.25 and 0.40, e.g. 0.3.

As can be seen in FIGS. 3, 4 and 8, the plotter 1 comprises first dampers 62a, connected to the return branch Cr of the ink recirculation circuit C, and second dampers 62b connected to the delivery branch Cm of the ink recirculation circuit C. The first damper 62a and the second damper 62b are identical to each other.

Ten pairs 63 of dampers 62, each including a first damper 62a and a second damper 62b, are provided in the preferred embodiment. Each pair 63 of dampers 62 is fluidly connected via a respective distributor 46 to a group 40 of printheads 34.

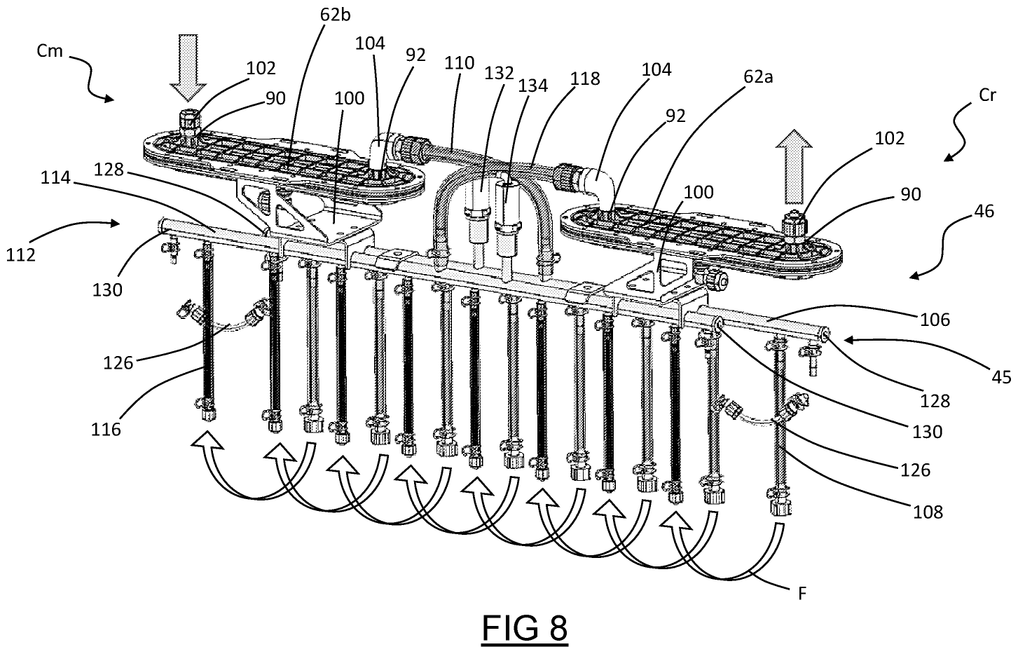

FIG. 8 schematically illustrates a pair 63 of dampers 62 connected to the distributor 46.

Each damper 62 is connected to the corresponding distributor 46 via a support element 100.

The distributor 46 comprises a delivery portion 45 including a straight primary delivery duct 106 and a plurality of secondary delivery duct 108 (only one shown in FIG. 8) branching off from the primary delivery duct 106.

The primary delivery duct 106 extends parallel to the sliding plane P and orthogonally to the first and second sliding directions S1, S2. The secondary delivery ducts 108 extend orthogonally to the primary delivery duct 106, in a vertical direction as shown in FIG. 8.

The primary delivery duct 106 is connected to the second damper 62b via a second connecting tube 110 connected to the second connector 104 located at the second opening 92 of the second damper 62b.

The distributor 46 comprises a return portion 112 including a straight primary return duct 114 and a plurality of secondary return ducts 116 (only one shown in FIG. 8) branching off from said primary return duct 114.

The primary return duct 114 extends parallel to the sliding plane P and orthogonally to the first and second flow directions S1, S2, horizontally in the figures (see also FIGS. 3 and 4). The secondary return ducts 108 extend orthogonally to the primary return duct 114, in a vertical direction as shown in FIG. 8.

The primary return duct 114 is connected to the first damper 62a via a first connecting tube 118 connected to the second connector 104 located at the second opening 92 of the first damper 62a.

The distributor 46 connects the first and second dampers 62a, 62b to a group 40 of printheads 34.

In particular, each of the secondary delivery ducts 108 is connected to an ink inlet 120 of a printhead 34 of the group 40 of printheads 34.

Each of the secondary return ducts 116 is connected to an ink outlet 122 of a printhead 34 of the group 40 of printheads 34.

The secondary delivery ducts 108 and return ducts 116 can be connected to the printheads 34 directly or by means of additional connectors 124, such as those shown in FIG. 3 illustrated connected to the printheads 34 and disconnected, for illustrative simplicity, from the secondary delivery ducts 108 and return ducts 116.

Preferred embodiments include bypass tubes 126 connecting the terminal ends 128 of the primary delivery duct 106 with the terminal ends 130 of the primary return duct 114.

As shown in FIG. 4, the first and second dampers 62a, 62b are placed at a fixed, predetermined distance D (measured in a direction perpendicular to the sliding plane P) from the ink inlet 120 and the ink outlet of the printheads 34.

The pressure inside the printheads 34 is provided by the sum of the pressure inside the accumulation chamber 88 of the damper 62 and the equivalent pressure of a column of ink of a height equal to the distance D separating the damper 62 from the printheads 34 in a vertical direction.

Therefore, this predetermined operating pressure is set in such a way that the pressure inside the printheads 34 is exactly equal to the predetermined differential pressure with respect to the external environment (e.g. it is equal to 998 mbar).

This operating pressure setting is implemented by setting the pumps acting on the recirculation circuit C.

For example, there is a first pressure sensor 132 connected to the first delivery branch 106 and configured to measure the pressure in the primary delivery duct 106. The first pressure sensor 132 is configured to at least indirectly measure the pressure inside the accumulation chamber 88 of the second damper 62b and, consequently, the inlet pressure to the plurality of printheads.

Alternatively or in combination, a second pressure sensor 134 is connected on the primary return duct 114 and is configured to measure the pressure in the primary return duct 114. The second pressure sensor 134 is configured to at least indirectly measure the pressure inside the accumulation chamber 88 of the first damper 62a.

The first damper 62a and the second damper 62b have similar or identical behaviour both during steady-state operation of plotter 1 and during a sudden drop or rise in pressure of the recirculation circuit C. Therefore, the following in relation to one damper 62 applies to all the dampers on the plotter 1.

During steady-state operation of the plotter 1, the ink is drawn from the ink tanks 200 and sent to the second dampers 62b via the delivery branch Cm of the recirculation circuit C. A small part of the ink is dispensed through the printheads 34 and the remaining ink is sent to the first dampers 62a and then reaches the tanks via the return branch Cr of the recirculation circuit C.

The second constant-pressure pump (placed in parallel to the return circuit Cr) keeps the pressure within the recirculation circuit C at a pressure such that the pressure in the accumulation chambers 88 is equal to the predetermined operating pressure, which corresponds to a pressure within the printheads 34 equal to the predetermined differential pressure with respect to the external environment.

When the carriage 24 is subjected to an acceleration (or deceleration) that causes an immediate drop in pressure in the recirculation circuit C, or when a printhead dispenses a significant amount of ink that causes a drop in pressure in the printhead 34, this drop in pressure is immediately propagated into the accumulation chamber 88. This drop in pressure in the accumulation chamber 88 is immediately compensated for by the expansion of the membrane 84 which, under the effect of constant pressure (e.g. atmospheric pressure) in the compensation chamber 94, expands in the accumulation chamber 88 raising the ink pressure in the accumulation chamber 88. This increase in pressure in the accumulation chamber 88 brings the pressure in the accumulation chamber 88 back to the predetermined operating pressure.

When the cause of the pressure drop in the recirculation circuit C ceases, the temporary pressure drop in the recirculation circuit C ceases and the membrane 84 expands in the compensation chamber 94 (as opposed to the constant pressure present in the compensation chamber 94), returning the accumulation chamber 88 to its initial volume and pressure conditions.

When the carriage 24 is subjected to an acceleration (or deceleration) that causes an immediate pressure increase in the recirculation circuit C, this pressure increase is immediately propagated into the accumulation chamber 88. This pressure increase in the accumulation chamber 88 is immediately compensated for by the expansion of the membrane 84, which expands in the compensation chamber 94 (in contrast to the constant pressure in the compensation chamber 94), lowering the ink pressure in the accumulation chamber 88. This decrease in pressure in the accumulation chamber 88 brings the pressure in the accumulation chamber 88 back to the predetermined operating pressure.

When the cause of the pressure increase in the recirculation circuit C ceases, the temporary pressure increase in the recirculation circuit C ceases and the membrane 84, under the effect of the constant pressure in the compensation chamber 94, expands in the accumulation chamber 88 returning the accumulation chamber 88 to its initial volume and pressure conditions.

Since the ink exiting the second dampers 62b reaches the fluid inlets 124 of the printheads 34 via the distributor 46, and since the distributor 46 comprises primary and secondary rigid delivery ducts 106, 108, and the first dampers 62b are placed at a fixed and predetermined distance D from the openings of the printheads 34, the ink reaches the printheads 34 without any pressure alterations with respect to the outlet from the first dampers 62b.

By way of example, the plotter 1 may comprise eighty printheads 34 divided into ten groups of eight printheads 34 for each group. Each group of printheads 34 is configured to dispense ink of one colour and is connected to a first damper 62a and a second damper 62b. The total number of dampers 62 is twenty.

For example, each printhead 34 may comprise 1536 nozzles 37. Each nozzle 37 is configured to emit ink droplets of approximately 10 picolitres in volume with an emission frequency of 20 KHz.

In this embodiment, the average ink flow Q flowing in each printhead group into the recirculation circuit C is approximately 147 ml/min, where the average ink flow Q is calculated according to formula (1) below:

$$Q = Vn \times Nn \times Nh \times f \qquad ( 1 )$$

Wherein:
Vn=volume of ink emitted by each nozzle in a single activation
Nn=number of nozzles on each printhead
Nh=number of printheads
f=nozzle emission frequency.

In this embodiment, the volume of the accumulation chamber 88 of each damper 62 active on said group of printheads is approximately 27 ml.

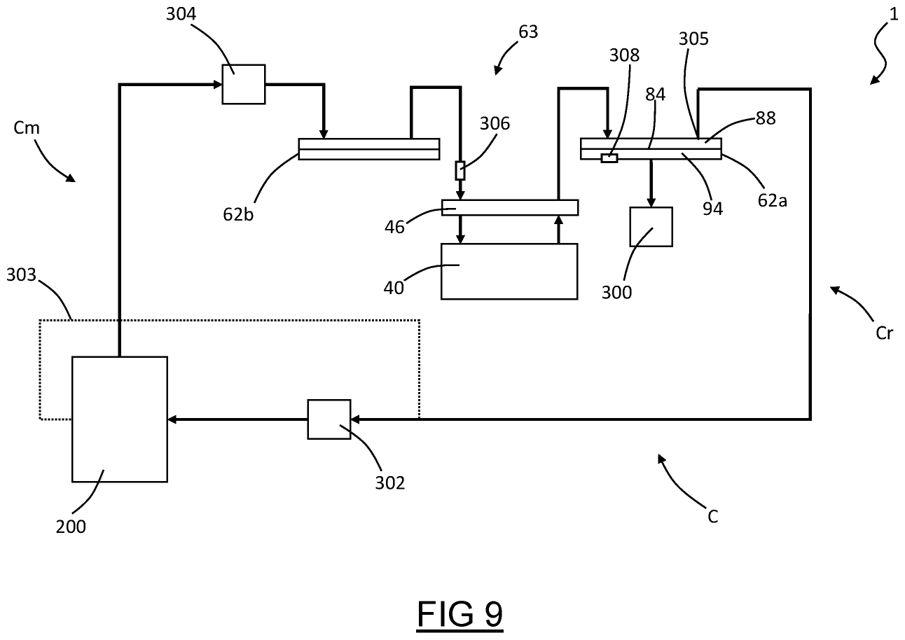

FIG. 9 schematically illustrates the ink recirculation circuit C of the plotter 1 according to a particularly preferred embodiment.

For the sake of simplicity, FIG. 9 illustrates a single pair 63 of dampers 62 fluidly connected via a distributor 46 to a single group 40 of printheads 34, but the following also applies, mutatis mutandis, when the plotter 1 includes a plurality of groups 40 of printheads 34 served by as many pairs 63 of dampers 62.

The conformation of the first damper 62a and the second damper 62b, their positioning along the recirculation circuit C and their operation (with the exception of the active control mode of the first damper 62a, described below) are entirely analogous to those described in relation to the previous figures.

The plotter 1 includes a first pump 300 connected to the compensation chamber 94 of the first damper 62a, located along the return branch Cr of the recirculation circuit C. The first 300 pump is, for example, the vacuum pump 151 shown in FIG. 5.

A second constant-pressure pump 302, briefly second pump 302, and a third constant-flow pump 304, briefly third pump 304, are also provided in the circuit to move the ink along the recirculation circuit C.

The second pump 302 is arranged in parallel with the return branch Cr of the recirculation circuit C (a bypass tube 303 is schematically shown by a broken line) and, when the plotter 1 is in operation, it sets a predetermined and constant pressure value along the return branch Cr and backwards at the ink outlet 305 at the accumulation chamber 88 of the first damper 62a.

The third pump 304 is located on the delivery branch Cm of the recirculation circuit C and is configured to draw ink from the tanks 200 and deliver it at a constant flow rate to the inlet to the accumulation chamber 88 of the second damper 62b.

The first pump 300 operates on suction, by applying a depression in the compensation chamber 94 of the second damper 62a and counterbalancing at least in part the negative pressure set in the accumulation chamber 88 by the second pump 302. The combined action of the first pump 300 and the second pump 302 keeps the membrane 84 of the first damper 62a in a certain equilibrium position.

The operation of the first pump 300 is controlled according to the pressure read by a first pressure sensor 306 at the inlet of the group of printheads 40. The sensor 306 is, for example, positioned, as in the case shown in FIG. 9, upstream of the distributor 46 (in this case it corresponds to the first pressure sensor 132 shown in FIG. 8); alternatively, a plurality of first sensors 306 can be provided, each being positioned at one of the tubes belonging to the distributor 46 or in proximity to an ink inlet 120 of a single printhead 34 (FIG. 4).

The provision of the first pump 300 allows the pressure in the accumulation chamber 88 of the first damper 62a to be quickly regulated by actively intervening in the position of the membrane 84 when pressures in the circuit deviate from the optimum operating pressure.

For example, when the first pressure sensor 306 reads a decrease in pressure at the inlet to the group of printheads 40 relative to the operating pressure, the first pump 300 is controlled to increase the depression (in other words, decrease the negative setpoint pressure to be achieved) applied in the compensation chamber 94 of the first damper 62b. In this way, the membrane 84 contracts towards the compensation chamber 94, increasing the volume and decreasing the hydraulic resistance of the accumulation chamber 88. This causes a higher fluid draw by the first damper 62a and a consequent pressure increase at the group of printheads 40.

Similarly, when the first pressure sensor 306 reads an increase in pressure at the inlet to the group of printheads 40 relative to the operating pressure, the first pump 300 is controlled to decrease the depression (in other words, to raise the negative setpoint pressure to be achieved) applied in the compensation chamber 94 of the first damper 62b. In this way, the membrane 84 expands towards the accumulation chamber 88, decreasing the volume and increasing the hydraulic resistance of accumulation chamber 88. This causes less fluid to be drawn in by the first damper 62a and a consequent drop in pressure at the group of printheads 40

The operation of the second pump 302 is controlled according to the pressure read by a second pressure sensor 308 at the first damper 62a. For example, the second pressure sensor 308 reads the air pressure in the compensation chamber 94 of the first damper 62a, but in non-illustrated variants it can be positioned and set to measure the ink pressure in the accumulation chamber 88 or an inlet/outlet pressure from the first damper 62a.

In this way, the second pump 302 is able to indirectly and dynamically regulate the operating point of the first pump 300. When the second pressure sensor 308 detects pressure changes at the first damper 62a—which is an indication that the first pump 300 has actively changed the position of the membrane 84 as a result of imbalance—the second pump 302 modifies the predetermined pressure value set at the ink outlet 305 of the first damper 62a, to return the membrane 84 to its equilibrium position, at which the first pump 300 operates at its optimum operating point.

Obviously, a person skilled in the art, in order to satisfy specific and contingent needs, can make numerous modifications and variations to the invention described above while remaining within the scope of protection defined by the following claims.

1. A plotter for inkjet printing, comprising:
a frame comprising a sliding guide;
a carriage slidably constrained to the sliding guide and movable along the sliding guide in a first printing direction and in a second printing direction opposite to the first printing direction, wherein the first printing direction and the second printing direction are contained within a sliding plane parallel to said sliding guide, and wherein the carriage supports at least one group of printheads wherein each printhead of said at least one group of printheads comprises a plurality of ink dispensing nozzles;
at least one tank configured to contain ink, arranged in a fixed position with respect to the frame;
an ink recirculation circuit, comprising a delivery branch configured to flow the ink from the at least one tank to the at least one group of printheads and a return branch configured to flow the ink from the at least one group of printheads to the at least one tank, said recirculation circuit comprising a plurality of tubes at least partially extending parallel to the sliding plane,
characterised in that it comprises at least one damper integral with the carriage placed between the at least one tank and the at least one group of printheads and connected to at least one of the delivery branch and the return branch of the ink recirculation circuit,
wherein said at least one damper comprises an ink accumulation chamber and a compensation chamber fluidly separated from the ink accumulation chamber by an expandable septum, said ink accumulation chamber being in fluid communication with said ink recirculation circuit and said compensation chamber being in fluid communication with at least one of the external environment, a source of compressed air or with a vacuum pump.

2. The plotter according to claim 1, wherein said at least one group of printheads comprises at least one printhead.

3. The plotter according to claim 1, wherein said accumulation chamber of the at least one damper has an elongated shape with a prevailing development axis parallel to said sliding plane and perpendicular to the first printing direction.

4. The plotter according to claim 1, wherein said accumulation chamber has a width dimension in a direction parallel to said sliding plane and parallel to said first printing direction, and a length dimension in a direction parallel to said sliding plane and perpendicular to said first printing direction; a ratio between said width dimension and said length dimension being preferably between 0.1 and 0.6, more preferably between 0.2 and 0.4, and even more preferably between 0.25 and 0.35.

5. The plotter according to claim 1, wherein said accumulation chamber comprises a first opening and a second opening; said first opening being connected to said at least one tank through tubes of said plurality of tubes and said second opening being connected to said group of printheads through a distributor.

6. The plotter according to claim 1, wherein said at least one damper is placed at a fixed and predetermined distance, along a direction perpendicular to the sliding plane, from said at least one group of printheads.

7. The plotter according to claim 1, wherein said at least one damper comprises a first damper connected to the return branch of the ink recirculation circuit, and
wherein said plotter comprises a first pump connected to the first damper, configured to regulate a pressure of ink flowing into the accumulation chamber of the first damper in response to pressure variations at an inlet to said at least one group of printheads.

8. The plotter according to claim 7, wherein said first pump is connected to the compensation chamber of the first damper to regulate an air pressure in said compensation chamber.

9. The plotter according to claim 7, wherein said first pump is configured to apply a depression in the compensation chamber of the first damper.

10. The plotter according to claim 9, wherein said first pump is configured to increase the depression applied in the compensation chamber of the first damper in response to a decrease in pressure acting at the inlet to said at least one group of printheads, and to decrease said depression in response to an increase in pressure acting at the inlet to said at least one group of printheads.

11. The plotter according to claim 7, comprising a first pressure sensor mounted along the delivery branch of the ink recirculation circuit to measure a pressure acting at the inlet to said at least one group of printheads, an output of said first pressure sensor being used to control the first pump.

12. The plotter according to claim 7, comprising a second constant-pressure pump connected in parallel to the return branch of the recirculation circuit, said second pump being configured to set a predetermined, preferably constant, pressure value at an ink outlet of the first damper.

13. the plotter according to-any one of claims claim 12, comprising a second pressure sensor mounted along the return branch of the ink recirculation circuit and connected to at least one of the first damper or a location near the first damper to measure a pressure acting in said first damper, an output of said second pressure sensor being used to control the second constant-pressure pump.

14. The plotter according to claim 7, wherein said at least one damper comprises a second damper connected to the delivery branch of the ink recirculation circuit.

15. The plotter according to claim 14, wherein said at least one group of printheads comprises a plurality of printheads, and a distributor comprising a primary return duct connected to the first damper and a primary delivery duct connected to the second damper, said primary return and delivery ducts developing parallel to said sliding plane and perpendicular to said first printing direction; a plurality of secondary return ducts, each being connected to said primary return duct; and a plurality of secondary delivery ducts, each being connected to said primary delivery duct; wherein said secondary return and delivery ducts develop perpendicularly to said sliding plane and are further connected to said plurality of printheads.

16. The plotter according to claim 15, wherein said distributor comprises at least one bypass tube connected between respective terminal ends of the primary return duct and of the primary delivery duct.
